(19) United States
(12) Patent Application Publication
(10) Pub. No.: US 2003/0126307 A1
(43) Pub. Date: Jul. 3, 2003

(54) Method and system for event management

(75) Inventors: Theresia Lindner, Seligenporten (DE); Stefan Bayer, Zirndorf (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 10/034,831

(22) Filed: Dec. 27, 2001

(51) Int. Cl. G06F 9/46; G06F 15/163; G06F 9/54; G06F 9/00

(52) U.S. Cl. 709/318

(57) ABSTRACT

In a computerized method and a networked system for event reporting in the context of network monitoring at a managed object which is part of a monitored network, an event report is generated when a set of event detection criteria is satisfied, the event report is marked with an identifier if a set of conditions is satisfied, the event report is sent from the managed object to a first database, a check is made at the first database to determine if the event report contains the identifier, and the event report is forwarded to a second database and is stored in the second database if the event report contains the identifier.

### BACKGROUND OF THE INVENTION

1. Field of the Invention

The invention relates to network monitoring, specifically to event reporting.

2. Description of the Related Art

3. Description of the Prior Art

The purpose of monitoring a network is to manage network performance, discover and solve network problems, and plan for network growth. According to Morris Sloman (Editor), “Network and Distributed Systems Management”, Addison-Wesley, England, 1994, pg. 303, monitoring can be defined as the process of dynamic collection, interpretation, and presenting of information concerning objects or software processes under scrutiny. Monitoring can be used for general network management, such as performance management, configuration management, fault management, or security management. One application of monitoring is event reporting which is explained below using definitions taken from the aforementioned text at pp. 303 to 347.

The network to be monitored is comprised of one or more managed objects. A managed object is defined as any hardware or software component whose behavior can be monitored or controlled by a management system. Hardware components may be hubs, routers, computers, bridges, etc. Each managed object is associated with a status and a set of events. The status of a managed object is a measure of its behavior at a discrete point in time. An event is defined as an atomic entity which reflects a change in the status of the managed object. The behavior of the managed object can be defined and observed in terms of its status and events.

The status of the managed object lasts for a certain time period. Examples of a status are “process is idle” or “process is running”. An event occurs instantaneously. Examples of an event are “message sent” or “process started”. Since the status of an managed object is normally changing continuously, the behavior of the managed object is usually observed in terms of a distinguished subset of events, called events of interest. Events of interest reflect significant changes in the status of the managed object.

In order to monitor the events of interest, events of interest must be detected. An event is said to have occurred when the conditions which are defined by event detection criteria are satisfied. These conditions are detected by appropriate instrumentation, such as software and hardware probes or sensors inserted in the managed object.

Event detection may be internal within or external from the managed object. Internally performed event detection is typically performed as a function of the managed object itself. Externally performed event detection may be carried out by an external agent which receives status reports of the managed object and detects changes in the status of the managed object.

The occurrence of the event may be detected in real-time or delayed. Once the event is detected, an event report is generated at the managed object. The event report may comprise an event identifier, type, priority, time of occurrence, the status of the managed object immediately before and after the occurrence of the event, and other application-specific status variables.

In order to monitor the dynamic behavior of the managed object, the event report may be conveyed from the managed object to a central unit. At the central unit event reports may be gathered, visualized, and recorded. The central unit may be a Network Management Station (NMS) on which an appropriate software, usually called a manager, resides. The manager executes management applications that monitor and control the managed objects. Physically, an NMS, sometimes called a console, is usually an engineering workstation with a fast CPU, megapixel color display, substantial memory, and abundant disk space. The NMS may comprise a database on which incoming reports sent by the managed objects, such as event reports, are stored.

Received reports can be viewed with the Graphical User Interface (GUI) of the NMS, for instance the display of the NMS.

Storage capacity of the NMS database is limited. Older records of the NMS database are therefore converted into ASCII-files and transferred, for example, to a hard disc of the NMS. This download may be carried out regularly, for instance on a weekly basis, or when the NMS database reaches a predefined storage size. Since network management systems are usually used to monitor the most recent behavior of the managed objects, this procedure is appropriate.

Specific events may have to be reported, perhaps for statistical reasons, on a long-term basis. Due to the short-term availability of reports stored on the NMS database, long-term reporting is complicated. Unless event reports for long-term reporting are analyzed while they are available on the NMS database, they must be recovered from their associated ASCII-files and loaded on an appropriate database for viewing. Since the NMS and its database are needed for on-line activities, i.e. for monitoring managed objects, the NMS and its database cannot be utilized for viewing recovered event reports. A second system appropriate for viewing recovered event reports has to be installed. Besides additional investment costs for the second system, this second system also has only limited storage capacity, further complicating long-term analysis and recording of event reports.

### SUMMARY OF THE INVENTION

It is an object of the present invention to provide a computerized method and a networked system which enable easy and cost-effective long-term event recording.

This object is achieved in accordance with the present invention in a computerized method, having the steps of generating, at a managed object which is part of a monitored network, an event report when a set of event detection criteria is satisfied, marking the event report with an identifier if a predefined set of conditions is satisfied, sending the event report from the managed object to a first database, checking at the first database if the event report has the identifier, forwarding the event report to a second database and storing it on the second database if the event report has the identifier.

According to the inventive computerized method, the managed object generates the event report when the set of event detection criteria is satisfied. The set of event detection criteria describes a predefined set of events of interest related to significant changes in the status of the managed object. For instance, if the managed object is a computer, then significant changes in the status of the managed object, i.e. the computer, can be an attempted login on that computer or a login from predefined hosts. Another significant event may be if the storage capacity of that computer reaches a predefined limit. If the computer is configured to control a machine, for instance a computed tomography apparatus or other medical device, then further significant events may be an x-ray tube failure or other problems associated with the medical device.

Furthermore, the managed object marks the event report with the identifier if the set of conditions is satisfied. This set of conditions may be a subset of the set of event detection criteria. An example of such a subset in the case of the computer controlled medical device is the set of events related to problems of components of the medical device. After that, the managed object sends the event report to the first database.

The first database receives the event report and is configured to check if incoming event reports comprise the identifier. If an incoming event report comprises the identifier, then the first database forwards the event report to the second database which stores the forwarded event report. The second database can particularly be used for long-term storing of event reports which are of special interest. For instance, if the managed object is the computer controlled medical device, and it marks with the identifier all event reports which are associated with problems of the medical device, then the second database contains only event reports related to problems of the medical device.

As a result, only a subset of event reports received at the first database is stored on the second database. Thus the second database does not reach its storage capacity too soon and the subset of event reports is therefore available for long-term analysis, for instance for monitoring problems of the medical device for a longer time period.

The network is monitored according to a preferred embodiment of the inventive computerized method with an agent-manager network management system. The agent-manager network management system is comprised of a manager which is software residing at a Network Management Station and one or more agents. An agent is software residing at the managed object. The agent is configured to generate and send the event report to the manager. Furthermore, the Network Management Station comprises the first database. Network management systems are commercially available. Examples of network management systems are HP OpenView, IBM NetView, or Novel NetWare. An advantage of the computerized method is that the network management system is not unnecessarily burdened by stored event reports which are used for long-term analysis. Additionally, the second system, which has been described in the introduction and is appropriate for viewing event reports which have been recovered from their associated ASCII-files, does not need to be installed.

The above object is also achieved in accordance with the invention in a networked system having a first database, a managed object, and a second database connected to the first database. Inventively, the managed object is configured to generate an event report when a set of event detection criteria is satisfied, then to mark the event report with an identifier if a set of conditions is satisfied, and to send the event report to the first database. The first database is inventively configured to receive the event report, check if the event report comprises the identifier, and forward the event report to the second database if the event report comprises the identifier. The inventive system is thus designed to be used to carry out the inventive computerized method.

### DESCRIPTION OF THE DRAWINGS

FIG. 1 is a pictoral network diagram illustrating the inventive networked system.

FIG. 2 is an entry mask for defining an identifier in accordance with the invention.

### DESCRIPTION OF THE PREFERRED EMBODIMENTS

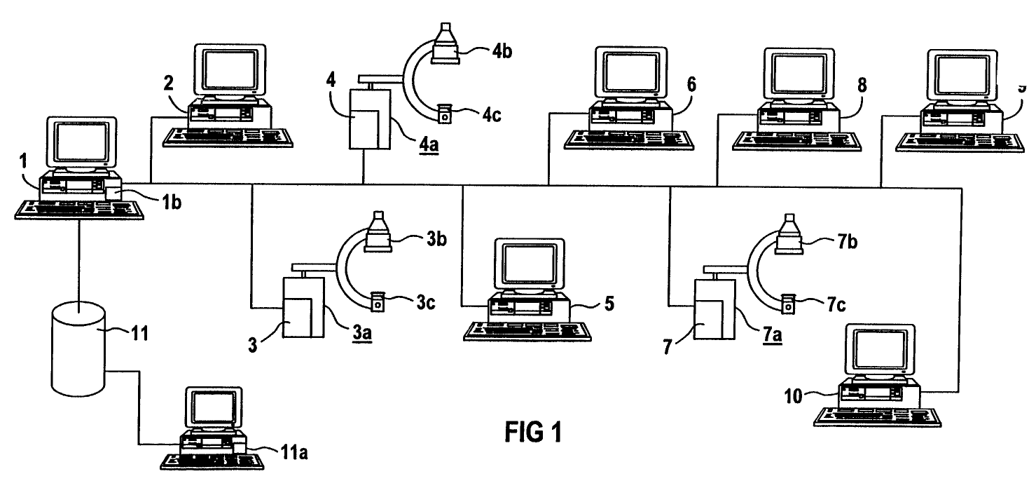

FIG. 1 depicts an example of a network which is has of several computers 1 to 10 and is monitored using the agent-manager network management system HP OpenView. One of the computers is a Network Management Station (NMS) 1. Computers 2, 5, 6, and 8 to 10 are standard PCs while computers 3, 4, and 7 control X-ray apparatuses 3a, 4a, and 7a, respectively.

At the NMS 1 resides a manager which communicates with agents residing on computers 2 to 10. The manager is software configured to receive reports sent by the agents. An agent is software configured to control and detect significant changes in the status of its corresponding computer according to a predefined set of event detection criteria. The sets of event detection criteria for each of the computers 2 to 10 include an attempted and failed login, the event when the storage space of the computer reaches 90% of its capacity, and link down.

The sets of event detection criteria for computers 3, 4, and 7 which control X-ray apparatuses 3a, 4a, and 7a, respectively, additionally include events corresponding to problems of components of the respective X-ray apparatus 3a, 4a, or 7a. These events comprise, for instance, a failure of a x-ray tube 3b, 4b, or 7b, failure of a x-ray detector 3c, 4c, or 7c, and failure of software which controls the x-ray apparatus 3a, 4a, or 7a, respectively.

Each agent is further configured to generate an event report when at least one of the criteria of the set of event detection criteria is satisfied. Each agent is further configured to send the generated event report to the manager of the NMS 1.

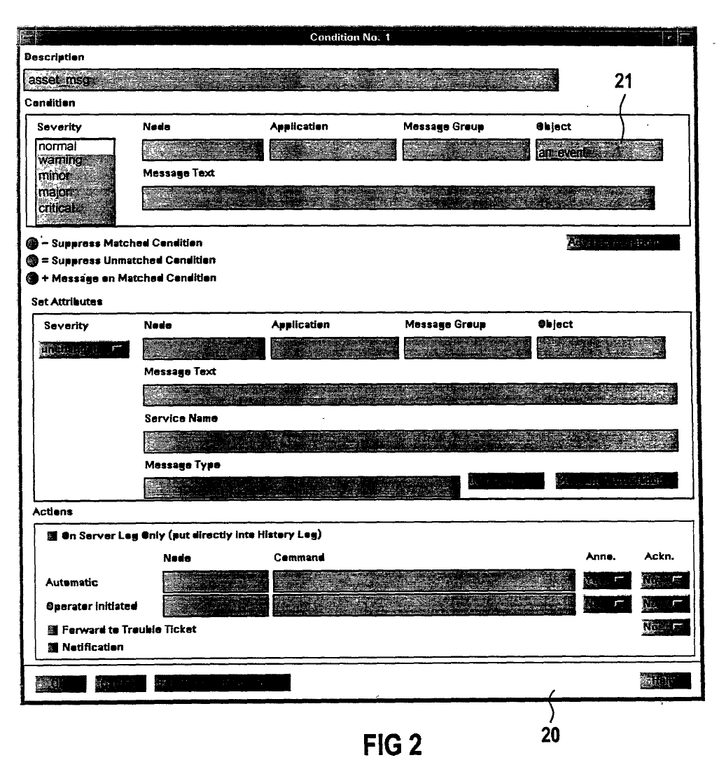

The agents of computers 3, 4, and 7 are further configured before sending a generated event report to include with a specific identifier to the generated event report when a predefined set of conditions is satisfied. The set of conditions for the agents residing on computers 3, 4, and 7 is associated with components of the respective x-ray apparatus 3a, 4a, and 7a. For the present exemplary embodiment the set of conditions is satisfied when a problem with the x-ray tube of the respective x-ray apparatus occurs. If the network management system HP OpenView is used, then the identifier can be defined using an entry mask 20 which can be viewed with the display of the NMS 1. The entry mask 20 is depicted in FIG. 2. The identifier for the set of conditions can be written in an object-field 21. For the present embodiment, the identifier is “an_event”.

After an event report is sent by the agent, it is received by the manager residing on the NMS 1. The manager of the NMS 1 is configured to store each received event report on a first database 1a of the NMS 1 and check each incoming event report if it contains the identifier “an_event”. If an incoming event report comprises the identifier “an_event”, then the manager copies the incoming event report and stores it also on a second database 11 which is connected to the NMS 1.

An example of an event to be reported is when the storage space of computer 3 reaches 90% of its capacity. Then the agent residing at the computer 3 generates a first event report including information about the type of event (storage space reached 90% of its capacity), the time when the storage space reached 90% of its capacity, and the status of computer 3 immediately before and after the storage space reached 90% of its capacity. Since the set of conditions does not include the criterion “storage space reaches 90% of its capacity”, the agent residing at the computer 3 does not add the identifier “an_event” to the generated first event report.

Since the first event report does not include the identifier “an_event”, the NMS 1 does not copy and forward the first event report to the second database 11.

Another example of an event to be reported is a failure of the x-ray tube 3a of the x-ray apparatus 3a. A failure of the x-ray tube 3a not only satisfies the set of event detection criteria, but also satisfies the set of conditions of the agent residing at the computer 3. Therefore, the agent not only generate a second event report which contains information about the type of this event (x-ray tube 3b failure), the time when the x-ray tube 3b failed, and the status of the x-ray apparatus 3a immediately before and after the x-ray tube 3b failed, but adds also the identifier “an_event” to the generated second event report.

Since the second event report includes the identifier “an_event”, the NMS 1 does not only store the received second event report on the first database 1a of the NMS 1, but also copies and forwards it to the second database 11 which is connected to the computer 11a. Consequently, the second database 11 contains all event reports which are received by the NMS 1 and are related to events defined by the second set of conditions.

The set of event detection criteria and the set of conditions are only examples. Computers which are managed objects can furthermore control devices other than medical devices such as the x-ray apparatuses 3a, 4a, and 7a.

Although modifications and changes may be suggested by those skilled in the art, it is the intention of the inventors to embody within the patent warranted hereon all changes and modifications as reasonably and properly come within the scope of their contribution to the art.

We claim as our invention:

1. A computerized method, comprising the steps of:
generating, at a managed object which is part of a monitored network, an event report when a set of event detection criteria is satisfied;
marking said event report with an identifier if a set of conditions is satisfied;
sending said event report from said managed object to a first database;
checking at said first database if said event report comprises said identifier; and
forwarding said event report to a second database and storing said event report on said second database if said event report comprises said identifier.

2. The computerized method of claim 1, comprising employing a set of conditions that is a subset of said set of event detection criteria as said set of conditions which must be satisfied for marking said report with said identified.

3. The computerized method of claim 1 comprising:
monitoring said monitored network with an agent-manager network management system; and
configuring an agent which resides on said managed object to generate and send said event report to a manager which resides at a Network Management Station which comprises said first database.

4. The computerized method of claim 1, comprising providing a medial device as said managed object.

5. The computerized method of claim 4, comprising employing a set of conditions related to components of said medical device as said set of conditions which must be satisfied for marking said report with said identified.

6. A networked system comprising:
a first database;
a managed object;
a second database connected to said first database;
said managed object being configured to:
generate an event report when a set of event detection criteria is satisfied;
mark said event report with an identifier if a set of conditions is satisfied;
send said event report to said first database;
said first database being configured to:
receive said event report;
check if said event report comprises said identifier; and
forward said event report to said second database if said event report comprises said identifier.

7. The system of claim 6, wherein said set of conditions is a subset of said set of event detection criteria.

8. The system of claim 6, wherein:
said network is monitored with an agent-manager network management system;
an agent which resides on said managed object generates and sends said event report to a manager; and
said manager resides on a Network Management Station which comprises said first database.

9. The system of claim 6, wherein said managed object is a medical device.

10. The system of claim 9, wherein said set of conditions is related to components of said medical device.

11. A computerized method, comprising the steps of:
receiving, at a first database which is connected to a network that includes a managed object, an event report due to a change in the status of said managed object;
checking at said first database if said event report comprises an identifier; and
forwarding said event report to a second database and storing said event report on said second database if said event report comprises said identifier.

12. The computerized method of claim 11, comprising generating said event report at said managed object when a set of event detection criteria is satisfied.

13. The computerized method of claim 11, comprising marking said event report, at said managed object with said identifier if a set of conditions is satisfied.

14. The computerized method of claim 13, employing a set of conditions that is a subset of said set of event detection criteria as said set of conditions which must be satisfied for marking said report with said identified.

15. The computerized method of claim 11, comprising:
monitoring said network with an agent-manager network management system;
configuring an agent which resides on said managed object to generate and send said event report to a manager which resides at a Network Management Station which comprises said first database.

16. The computerized method of claim 11, comprising employing a medical device as said managed object.

17. The computerized method of claim 16, comprising generating said event report at said managed object when a set of event detection criteria is satisfied.

18. The computerized method of claim 16, comprising marking said event at said managed object report with said identifier if a set of conditions is satisfied.

19. The computerized method of claim 18, comprising employing set of conditions that is a subset of said set of event detection criteria as said set of conditions which must be satisfied for marking said report with said identified.

20. The computerized method of claim 18, comprising employing a set of conditions related to components of said medical device as said set of conditions which must be satisfied for marking said report with said identified.
